(19) United States
(12) Patent Application Publication
(10) Pub. No.: US 2018/0127639 A1
(43) Pub. Date: May 10, 2018

(54) COMPOSITIONS AND METHODS OF USING DEGRADABLE AND NONDEGRADABLE PARTICULATES FOR EFFECTIVE PROPPANT PLACEMENT

(71) Applicant: Schlumberger Technology Corporation, Sugar Land, TX (US)

(72) Inventors: Changsheng XIANG, Houston, TX (US); Andrey YAKOVLEV, Houston, TX (US); Mohan Kanaka Raju PANGA, Sugar Land, TX (US)

(21) Appl. No.: 15/344,274

(22) Filed: Nov. 4, 2016

(51) Int. Cl. C09K 8/68; C09K 8/80; E21B 43/26; E21B 43/267

(52) U.S. Cl. CPC C09K 8/68; C09K 8/80; C09K 2208/10; E21B 43/267; C09K 2208/08; E21B 43/26

(57) ABSTRACT

Methods herein include treating a formation including pumping a fracturing fluid including proppant, non-degradable fibers, and a degradable component into fractures in the formation. Fracturing fluids herein include an aqueous base fluid, a proppant materials, non-degradable fibers, and a degradable component. Methods of treating a formation include alternately pumping a first fracturing fluid having proppant into a wellbore penetrating the formation and pumping a second fracturing fluid that is substantially proppant-free into the wellbore penetrating the formation, wherein at least one of the first fracturing fluid and the second fracturing fluid comprise a non-degradable fiber.

### BACKGROUND

Hydrocarbons (e.g., oil, natural gas, etc.) may be obtained from a subterranean formation by drilling a wellbore that penetrates the hydrocarbon-bearing formation. Fracturing operations may be conducted in a wellbore to improve the production of fluids from the formation surrounding the wellbore. A variety of fracturing techniques can be employed, and available systems enable multi-stage stimulation to be performed along the wellbore. Hydraulic fracturing techniques generally involve pumping a fracturing fluid downhole and into the surrounding formation upon its fracture due to the high pressures involved.

More specifically, hydraulic fracturing techniques inject a fracturing fluid into a wellbore penetrating a subterranean formation thereby forcing the fracturing fluid against the wellbore walls at pressures high enough to crack or fracture the formation, creating or enlarging one or more fractures. Proppant present in the fracturing fluid is then entrained within the fracture by the ingress of the fracturing fluid into the created or enlarged crack, thereby preventing the fracture from closing and thus providing for the improved flow produced fluids from the formation. Proppant is thus used to hold the walls of the fractures apart in order to create conductive paths that can facilitate the flow of fluids through the formation and into the wellbore after pumping has stopped. Being able to place the appropriate proppant at the appropriate concentration to form a suitable proppant pack is thus important for the success of a hydraulic fracturing operation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure relates to a method of treating a formation including pumping a fracturing fluid including proppant, non-degradable fibers, and a degradable component into fractures in the formation.

The present disclosure also relates to a fracturing fluid including an aqueous base fluid, a proppant materials, non-degradable fibers, and a degradable component.

The present disclosure also relates to a method of treating a formation including alternately pumping a first fracturing fluid having proppant into a wellbore penetrating the formation and pumping a second fracturing fluid that is substantially proppant-free into the wellbore penetrating the formation, wherein at least one of the first fracturing fluid and the second fracturing fluid comprise a non-degradable fiber.

Other aspects and advantages of the claimed subject matter will be apparent from the following description and the appended claims.

### BRIEF DESCRIPTION OF DRAWINGS

FIG. 1 shows a schematic of a proppant pack containing degradable fibers, non-degradable fibers, and proppant directly after placement within a fracture.

FIG. 2 shows a schematic of the proppant pack of FIG. 1 after the degradable fibers have degraded and been removed from the proppant pack.

FIG. 3 shows a schematic of a pulsed stimulation treatment according to the present disclosure.

FIG. 4 shows a schematic of the pulsed stimulation treatment shown in FIG. 3 after the degradable fibers or particulates have degraded and been removed.

### DETAILED DESCRIPTION

Embodiments disclosed herein relate generally to fracturing fluid compositions and methods of using said compositions during hydraulic fracturing operations. More specifically, embodiments disclosed herein relate to fracturing methods that use fluids that include non-degradable fibers, and optionally a degradable component, such as in multi-staged fracturing fluids whether in combination within a fluid or in separate fluids, and to fracturing fluids including a combination of a degradable component and non-degradable fibers.

As discussed above, hydraulic fracturing operations are used to create fractures in subterranean formations in order to increase their permeability and facilitate their release of oil and gas that may be trapped therein. In hydraulic and acid fracturing, a first fluid called the pad may be injected into the formation to initiate and propagate the fracture. During hydraulic fracturing, high pressure pumps on the surface inject the fracturing fluid into a wellbore adjacent to the face or pay zone of a geologic formation. The first stage, the “pad stage,” involves injecting a first treatment fluid into the wellbore at a sufficiently high flow rate and pressure sufficient to literally break or fracture a portion of surrounding strata at the sand face. The pad stage is pumped until the fracture has sufficient dimensions to accommodate the subsequent slurry pumped in the proppant stage. In one or more embodiments, the pad stage may be energized or foamed, although, it is also within the scope of the disclosure that the fluid is of the same type as the subsequent, proppant-containing stages.

After the fracture is induced, proppant is generally injected with the second treatment fluid into the fracture as a slurry or suspension of particles in the fracturing fluid during what is referred to herein as the “proppant stage.” In the proppant stage, proppant can be injected with non-degradable fibers and/or degradable fibers or particulates in one or more segregated substages alternated between a “proppant-rich substage” and a “proppant-lean substage.” In one or more embodiments, the degradable fibers or particulates and non-degradable fibers may be included within the proppant-rich substage and/or the proppant-lean substage. When the proppant-rich substage includes a mixture of proppant with non-degradable fibers or degradable components, the one or more substages may also be referred to herein as a “mixed substage.” Further, the proppant-rich substage, proppant-lean substage and/or mixed substages can be separated by one or more optional “carrier substages”, which are substantially free of proppant and can also be substantially free of other materials, such as the non-degradable fibers or degradable components. During the proppant-rich substage, proppant is transported into the fractures by fluids to assist in the formation of proppant packs or pillars within the fracture. These proppant packs or pillars are desired because they localize masses of proppant throughout the fracture thereby providing sufficient support to keep the fracture open while also providing channels between the proppant pillars for the oil and gas to flow from the formation and into the wellbore for collection. In particular embodiments, the proppant-rich substage may be mixed and include at least include non-degradable fibers and the proppant-lean substage may optionally include degradable materials.

In one embodiment, the pad stage is followed with a sequence of proppant-rich and proppant-lean stages to create a network of open channels inside the fracture. The durations of the proppant-rich and proppant-lean stages, as well as the concentration of proppant may be selected based on the geo-mechanical properties of the formation and desired fracture geometry. The volumes of the proppant-rich and proppant-lean stages may be the same or different and may vary from 1 bbl to 30 bbl. As a result, when such substages are used, the proppant may not completely fill the fracture. Rather, spaced proppant clusters form as pillars with the proppant-lean substage (containing, for example non-degradable fibers and/or degradable materials, in various embodiments) filling the channels between them. It is envisioned that the non-proppant materials (non-degradable fibers or degradable components) may have a different permeability (increasing fluid flow therethrough) than a proppant pack of proppant alone (and thus may be included in increase fluid conductivity through the fracture and/or may aid in stabilization of formed proppant pillars. The volumes of proppant-rich, proppant-lean, and carrier sub-stages as pumped can be different. That is, the volume of the proppant-lean substage and any carrier substages can be larger or smaller than the volume of the proppant and/or any mixed substages. Furthermore, the volumes and order of injection of these substages can change over the duration of the proppant stage. That is, proppant-rich substages pumped early in the treatment can be of a smaller volume then a proppant-rich substage pumped later in the treatment. The relative volume of the substages can be selected by the engineer based on how much of the surface area of the fracture it is desired to be supported by the clusters of proppant, and how much of the fracture area is desired as open channels through which formation fluids are free to flow. In some embodiments, the non-degradable materials may be contained in the proppant-rich substage, and the proppant-rich substage may be alternated with a carrier substage. In other embodiments, the non-degradable materials may be contained in a proppant-lean substage that is alternated with proppant-rich substage. In some embodiments, a degradable component may be included in a proppant-lean substage that is alternated with a proppant-rich substage (where a non-degradable component is present in either the proppant-rich substage or the proppant-lean substage). In other embodiments, a degradable component may be included in a proppant-rich substage, and the proppant-rich substage may be alternated with a proppant-lean substage or a carrier substage (where a non-degradable component is present in either the proppant-rich substage or the proppant-lean substage).

The addition of non-degradable fibers to the fracturing fluids used during proppant stages of the stimulation treatments, such as in the proppant-rich substage but also in the proppant-lean substage, may help to stabilize proppant suspension at high temperatures, improve proppant transport into far field fracture zones and consolidate the proppant into stable packs or pillars. In this disclosure, non-degradable fibers include any fibrous materials that remain substantially intact under downhole/subterranean conditions and do not degrade or decompose during the time period that a skilled artisan would expect a propped fracture to remain effectively open and propped. In one or more embodiments, non-degradable fibers that may be added to fracturing fluids may include cellulosic fibers, such as cellulose acetate, nanocellulose, and pulp, or the non-degradable fibers may be synthetic fibers, such as polyolefin-based fibers, polyamide fibers, synthetic polyester fibers, polyethylene fibers, polybenzimidazole fibers, modacrylic fibers, nylon fibers, acrylic fibers, Zylon fibers, Dyneema fibers, aramids fibers, polyvinyl choloride fibers, rayon fibers, glass fibers, or other synthetic polymer-based fibers, or a mixture of cellulosic fibers and synthetic polymer-based fibers. Cellulosic fibers are generally found to be hydrophilic and may swell in contact with water and be highly flexible within the fracture environment. Synthetic polymer-based fibers are generally hydrophobic, not swelling in contact with water, and can be more rigid and less flexible within the downhole environment than cellulosic fibers. In one or more embodiments, the non-degradable fibers may be substantially non-adhering, i.e., they do not adhere to the proppants at downhole conditions.

Cellulose itself constitutes the most abundant renewable and environmentally friendly raw material available on earth. For example, raw materials including wood, recycled paper, and agricultural residues such as bagasse, cereal straw, bamboo, reeds, esparto grass, jute, flax, and sisal all are comprised of cellulose fibers that may be converted into a variety of product including pulp fiber. Depending on the particular application requirements, the raw material processing conditions may be altered to produce a variety of cellulose-based materials that vary in terms of dimension and shape. For example, pulp fibers may generally range from 1 micron to 10 millimeters in length, powdered cellulose may generally range from 1 micron to 1 millimeter, nanofibrillated cellulose may generally range from 100 nanometers to 1 micron, microfibrillated cellulose may generally range from 100 nanometers to 500 microns, and the like. The above length distributions, and any other dimensional details that follow, are all based off of the values for dry fibers. It is to be understood that hydrophilic fibers, for example, which may be some of the non-degradable fibers of the present disclosure, may elongate and/or swell upon their hydration from a dried state.

However, in some instances, use of non-degradable fibers may result in reduced fluid conductivity within the resulting fractures as the non-degradable fibers occupy space within the fracture. In one or more embodiments, the use of degradable fibers or particulates in combination with non-degradable fibers may allow for effective proppant suspension and placement while also providing increased fluid conductivity within the fracture. In one or more embodiments, the degradable fibers or particulates may degrade over a period of time due to at least one of the conditions experienced downhole or they may be triggered to degrade by the application of a specific treatment. For example, the degradable fibers or particulates may degrade and be removed in various embodiments by flushing, dissolving, softening, melting, breaking, or degrading, wholly or partially, via a suitable activation mechanism, such as, but not limited to, temperature, time, pH, salinity, solvent introduction, catalyst introduction, hydrolysis, and the like, or any combination thereof. The activation mechanism can be triggered by ambient conditions in the formation, by the invasion of formation fluids, exposure to water, passage of time, by the presence of incipient or delayed reactants in or mixed with the degradable particles, by the post-injection introduction of an activating fluid, or the like, or any combination of these triggers. Once degraded, formation fluid may displace any remnants of the degradable components in the fracture or the remnants may be removed hydraulically by flushing the fracture with formation fluid and/or an injected flushing or back-flushing fluid. In one or more embodiments, the degradable fibers or particulates may be materials made of substituted and unsubstituted lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, other polyesters, and mixtures thereof.

In one or more embodiments, the non-degradable fibers used may have a length with a lower limit of any of 250 microns, 325 microns, 400 microns, 500 microns, or 1 millimeter with an upper limit of any of 3 millimeters, 4.5 millimeters, 6 millimeters, 8 millimeters, or 10 millimeters, where any lower limit can be used in combination with any upper limit. In one or more embodiments, a non-degradable fiber sample may be further fractionated to achieve a more narrow length distribution within the ranges listed above. In one or more embodiments, the width (e.g., dimension opposite the length) of the non-degradable fibers may be broadly from about 500 nanometers to 500 microns or more narrowly from about 10 microns to 50 microns, or from about 15 microns to 45 microns, or from about 20 microns to 40 microns. In one or more embodiments, the aspect ratio (length to width) of the non-degradable fibers used in fracturing fluids of the present disclosure may be from about 5 to 1000, or from about 6.5 to 700, or from about 8 to 500, or from about 10 to 300. In one or more embodiments, the degradable fibers may have lengths of approximately from 1 mm to 30 mm, from 2 mm to 25 mm, from 3 mm to 18 mm, and cross-section diameters of approximately from 5 μm to 200 μm or from 10 μm to 100 μm. In other embodiments, the degradable fibers may have straight or crimped configurations. In one or more embodiments, the total amount of fibers (e.g, degradable fibers and non-degradable fibers or only one type of fibers on their own), or fibers and degradable particulates, within a given stage may be from about—0.01% to 2% by weight, or from 0.25% to 1.75% by weight, or from about 0.5% to 1.5%, or from about 0.1% to 0.5% by weight of the fracturing fluid. In one or more embodiments, when degradable components are present in the same fluid stage as the non-degradable fibers, the weight percent of non-degradable fibers to the total amount of degradable components is from about 5% to 95%, from about 25% to 75%, from about 40% to 60%, from about 50% to 95%, from about 60% to 90%, from about 65% to 85%, or about 70% to 80%.

In one or more embodiments, the fracturing fluid may include an aqueous base fluid, including fresh water, salt water, and/or brines. More specifically the fracturing fluid may be a low viscosity “slickwater” type fluid. In one or more embodiments, the fracturing fluid may include at least one of the following additives used in oilfield applications: friction reducers, clay stabilizers, biocides, thickeners, corrosion inhibitors, and/or proppant flowback control additives. In one or more embodiments, proppants may be included in the wellbore fluid. The type of proppant is not to be specifically limited and it is the express intent of this application that any examples known to those of skill in the art may be used.

In one or more embodiments, the degradable fibers or particulates and non-degradable fibers may be used within various types of fluid systems (e.g., slickwater, linear gel, crosslinked gel, foamed, etc.) as needed to effectively complete the proppant placement. In one or more embodiments, the fluid system may include a thickener selected from natural polymers including guar (phytogenous polysaccharide) and guar derivatives (e.g., hydroxypropyl guar and carboxymethylhydroxypropyl guar) and synthetic polymers including polyacrylamide copolymers. Additionally, viscoelastic surfactants that form elongated micelles are another class of non-polymeric viscosifiers that may be added to the fluid in addition to or independently from the polymeric thickeners. Other polymers and other materials, such as xanthan, scleroglucan, cellulose derivatives, polyacrylamide and polyacrylate polymers and copolymers, viscoelastic surfactants, and the like, can be used also as thickeners. For example, water with guar represents a linear gel with a viscosity that increases with polymer concentration.

In one or more embodiments, cross-linking agents may be added to the fluid to crosslink polymers therein and thereby increase the gel viscosity and/or create visco-elasticity. Crosslinking agents for guar, guar derivatives, cellulose and cellulose derivatives and synthetic polymers including polyacrylamide type polymers include salts of boron, titanium, zirconium, and aluminum.

Proppants may comprise naturally occurring sand grains or gravel, man-made or specially engineered proppants, such as fibers, resin-coated sand, or high-strength ceramic materials, e.g. sintered bauxite. Also other proppants like, plastic beads such as styrene divinylbenzene, and particulate metals may be used. Proppant used in this application may not necessarily require the same permeability properties as typically required in conventional treatments because the overall fracture permeability will at least partially develop from formation of channels based on the degradation of the degradable material. Other proppants may be materials such as drill cuttings that are circulated out of the well. Also, naturally occurring particulate materials may be used as proppants, including, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc., including such woods that have been processed by grinding, chipping, or other form of particalization, processing, etc, some nonlimiting examples of which are proppants made of walnut hulls impregnated and encapsulated with resins. The proppant collects heterogeneously or homogenously inside the fracture to “prop” open the new cracks or pores in the formation. The proppant creates planes of permeable conduits through which production fluids can flow to the wellbore. By selecting proppants having a contrast in one of such properties such as density, size and concentrations, different settling rates will be achieved. The fracturing fluids may be of high viscosity, and therefore capable of carrying effective volumes of proppant material.

The selection of proppant can balance the factors of proppant long-term strength, proppant distribution characteristics and proppant cost. The proppant can have the ability to flow deeply into the hydraulic fracture and form spaced pillars that resist crushing upon being subjected to the fracture closure stress. Relatively inexpensive, low-strength materials, such as sand, can be used for hydraulic fracturing of formations with small internal stresses. Materials of greater cost, such as ceramics, bauxites and others, can be used in formations with higher internal stresses. Further, the chemical interaction between produced fluids and proppants, which can significantly change the characteristics of the proppant, can be considered.

Because one or more embodiment may not rely on the porosity or permeability of the packed proppant matrix to impart flow conductivity to the fracture, the availability of the option to select a wider range of proppant materials can be an advantage of the present embodiments. For example, proppant can have any size or range of mixed, variable diameters or other properties that yield a high-density, high-strength pillar, which can form a proppant matrix that has high or low porosity and high or low permeability—proppant porosity and permeability are not so important in some embodiments—because fluid production through the proppant matrix is not required in some embodiments. Also, an adhesive or reinforcing material that would plug a conventional proppant pack can be employed in the interstitial spaces of the proppant matrix herein, such as, for example, a settable or crosslinkable polymer which can be set or crosslinked in the proppant. Thus, a proppant pillar of suitable strength can be successfully created using sand with particles too weak for use in conventional hydraulic fracturing. Sand costs substantially less than ceramic proppant. Additionally, destruction of sand particles during application of the fracture closure load can improve strength behavior of the same cluster consisting of proppant granules. This can occur because the cracking/destruction of proppant particles decreases the cluster porosity thereby compacting the proppant. Sand pumped into the fracture to create proppant clusters does not need good granulometric properties, that is, the narrow particle size or diameter distribution required for a permeable proppant pack in conventional fracturing. For example, in one embodiment, it is possible to use 50 tons of sand, wherein 10 to 15 tons have a diameter of particles from 0.002 to 0.1 mm, 15 to 30 tons have a diameter of particles from 0.2 to 0.6 mm, and 10 to 15 tons have a diameter of particles from 0.005 to 0.05 mm. It should be noted that conventional hydraulic fracturing would require about 100 tons of a proppant more expensive than sand to obtain a similar value of hydraulic conductivity for fluid passage through the continuous-porosity proppant matrix in the propped fracture.

The proppant blend can include elongated proppants. An important parameter for suitable materials for elongated proppant is a suitable material deformability, the ability of a material to deform without breaking (failure) under the action of load. Material deformability may be measured as the degree of deformation in a large number of tests, for example tension, compression, torsion, bending etc. In some cases, the loading force is applied in such a way that uniform deformation is sustained, and the direction of the applied force does not change during the entire process of loading (the geometrically linear case). Also a very important property of the elongated proppant particles is the curvature.

Some useful shapes of elongated particles are rods, ovals, plates and disks. The shapes of the elongated particles need not necessarily fit into any of these categories, i.e. the elongated particles may have irregular shapes. While described are elongated particles such as rods or elongated rods, any elongated shape, for example rods, ovals, plates and disks may be useful. The maximum length-based aspect ratio of the individual elongated particles should be less than about 25. In this discussion, when we refer to elongated particles, we intend the term to refer to stiff, non-deformable particles having an aspect ratio of less than about 25. The elongated particles are preferably made from ceramic materials the same as or similar to those used in conventional intermediate and high strength ceramic proppants. However, any material may be used that has the proper physical properties, in particular Young's Modulus. Particularly suitable materials include ceramics such as glass, bauxite ceramic, mullite ceramic, and metals such as aluminum and steels such as carbon steel, stainless steel, and other steel alloys.

Some suitable sizes for the elongated particles are as follows. If the particles can be characterized most straightforwardly as cylinders or fibers (with the understanding that these and other characterizations may be approximations of the shapes and the actual shapes may be irregular), then the “lengths” may range from about 0.1 mm to about 30 mm, and the “diameters” from about 0.1 mm to about 10 mm, preferably from about 0.1 mm to about 3 mm. If the particles can be characterized most straightforwardly as disks or plates, then the “thickness” may range from about 10 microns to about 5000 microns and the “diameter” may range from about 0.5 mm to about 25 mm, or the “length” may range from about 1 mm to about 20 mm and the “width” may range from about 1 mm to about 20 mm. The elongated particles may be used with any natural or synthetic proppant or gravel. For rods (fibers) the ratio of the diameter of the elongated particle to the diameter of the conventional (spherical) proppant may range from about 0.1 to about 20; the preferred ratio ranges from about 0.5 to about 3. For plates or disks, the ratio of the diameter of the conventional proppant to the thickness of the elongated particle may range from about 1 to about 100; the preferred ratio is from about 4 to about 20; the optimal value is about 5. For plates or disks, the ratio of the diameter of the conventional proppant to the thickness of the plate or disk may range from about 1 to about 100; the preferred range is from about 3 to about 20; the optimal is about 5. For plates or disks, the ratio of the length or width of the plate or disk to the diameter of the conventional proppant may range from about 1 to about 50; the preferred range of the ratio is from about 5 to about 10. The most important feature of the elongated proppants is that they must be stiff, low-elasticity, and low-deformability materials. The Young's Modulus should be between about 0.02 and about 1100 GPa. The dimensionless cross-sectional moment of inertia should be between about 0.1 and 0.425. Particles having a low Young's Modulus will be sufficiently stiff if they have a high enough ratio of dimensionless cross sectional moment of inertia to dimensionless length (for example rods with a large diameter and short length) although they still must have a high enough aspect ratio to produce an increase in permeability due to the wall effect.

An example of some suitable elongated particles is ceramic rods that are composed of at least about 92% alumina, at least about 2% silica, and at least about 1% titanium. The rods have a diameter of about 0.85 to 0.90 mm and a length of about 5-7 mm. They have a Young's Modulus of about 160 GPa, a bending strength of about 300 MPa, a specific gravity of about 3.71 g/cm 3 and a roundness of about 0.9.

In one embodiment, the elongated particles may be used without conventional proppant as the only proppant employed. In a second embodiment, the elongated particles may also be mixed with conventional proppant. At least a portion of a fracture may be packed with elongated particles and non-degradable fibers (and optionally degradable components). If the entire fracture is not packed with elongated proppant, then the remaining part of the fracture may be propped with conventional proppant or sand with non-degradable fibers (and/or degradable components) or with a mixture of elongated and conventional proppant with non-degradable fibers (and/or degradable components). Such a mixture may vary from about 1 to about 99% elongated proppant and may include more than one elongated proppant shape, length, diameter, and aspect ratio. For rods, the range is from about 20% to about 100% by volume for fracturing or from about 50% to about 100%; for plates the range is from about 5% to about 50% by volume for fracturing or from about 5 to about 15%. Mixtures of different sizes with the same shape as well as mixtures of different shapes and different sizes may be used. Improvements may be obtained from, for example, mixtures of plates and rods, and mixtures of conventional proppants and plates and rods. Mixtures of different shapes may increase flow back properties as well as provide additional conductivity.

In one or more embodiments, the fracturing fluids of the present disclosure may also include a biocide and/or a surfactant.

As discussed above, the use of degradable fibers or particulates in combination with non-degradable fibers may allow for effective proppant placement while also providing increased fluid conductivity within the fracture when compared with using either type of fibers alone. In practice, there may be a multitude of ways to combine the use of non-degradable fibers and degradable fibers or particulates in a fracturing/stimulation job. In one or more embodiments, degradable fibers and non-degradable fibers may be included in the same fracturing fluid along with proppant. In one or more embodiments, a pulsed application of fracturing fluid may be used where fluids containing non-degradable fibers and proppant are provided in a pulse and a separate pulse of fracturing fluid containing degradable fibers only is applied. In one or more embodiments, a pulsed application of fracturing fluid may be used where a base fracturing fluid is continuously pumped but the proppant is pulsed/added at determined intervals. In the aforementioned embodiment, degradable fibers and/or non-degradable fibers may also be added to the continuously pumped base fracturing fluid, either along with the proppant during the same intervals or in separate intervals. These methodologies will be described in further detail in the paragraphs below.

In one or more embodiments, a stimulation job may be performed and proppant placement within a fracture may be achieved by continuously pumping a fluid including a mixture of degradable fibers or particulates and non-degradable fibers with proppant into a wellbore. In these embodiments, the proppant pillars or packs that form within the fracture will include an intimate mixture of each of the components indicated above. However, over time, the degradable component will degrade and be flushed from the proppant pillars or packs, leaving only the non-degradable component and the proppant within the proppant pillars or packs. The absence of the degradable component after it degrades may leave micro-channels within the proppant pack, thereby improving the fluid conductivity therethrough and allowing for easier production of desirable components from the formation. In one or more embodiments, the micro-channels in the proppant pack may have widths on the order of millimeters or roughly the dimensions of the degradable fibers or degradable particulates that, once degraded, form the micro-channels.

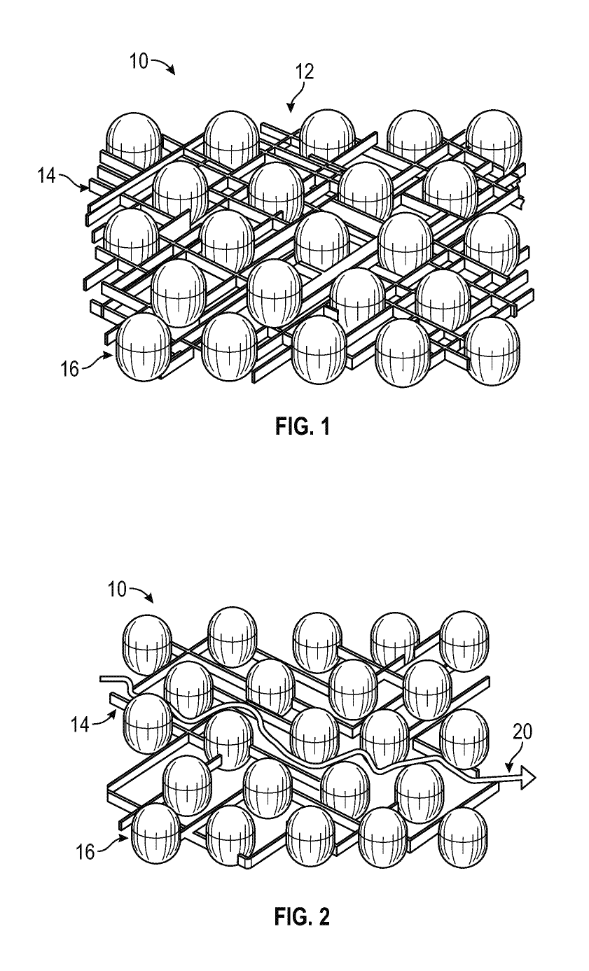

FIG. 1 shows a schematic of a proppant pack 10 directly after placement within a fracture, the proppant pack 10 containing degradable fibers 12, non-degradable fibers 14, and proppant 16. In FIG. 1 the proppant 16 is represented by the round balls and the fiber components are shown filling in throughout the interstitial space between the round balls. FIG. 2 shows an idealized representation of the proppant pack 10 of FIG. 1 after passage of enough time for the degradable fibers 12 to degrade, whether under the action of an applied stimulus or due to the high temperature high pressure conditions within the wellbore alone, and be removed from the proppant pack. As shown in FIG. 2, once the degradable fibers are removed from the proppant pack 10, the proppant pack 10 has an increased permeability due to the formation of micro-channels 20 in the spaces where the degradable fibers once occupied, and fluids are capable of circulating easier through the proppant pack.

In one or more embodiments, a stimulation job may be performed by a pulsed application of fracturing fluids, where fracturing fluids containing non-degradable fibers and proppant are provided in a slug and a separate slug of fracturing fluid containing only degradable fibers or particulates is subsequently applied and this alternating sequence is repeated until the stimulation job is deemed complete. It is also envisioned that the initial slug of fracturing fluid may be the slug that does not contain proppant, while a subsequent slug is the slug that does contain proppant. The application of alternating pulses of fracturing fluid including a “dirty” slug (i.e., including proppant) and a “clean” slug (i.e., not including proppant) may result in the heterogeneous placement of proppant within a fracture. When the non-degradable fibers are included in the dirty slug they will be intimately incorporated into the proppant pillars or packs formed, while the degradable fibers or particulates included in the clean slug will be present within the areas surrounding the proppant pillar or pack. Thus, upon the degradable components degradation there may be channels that form around the proppant pillars or packs that allow for increased conductivity within the fracture. In one or more embodiments, the channels formed around the proppant packs may have widths on the order of feet.

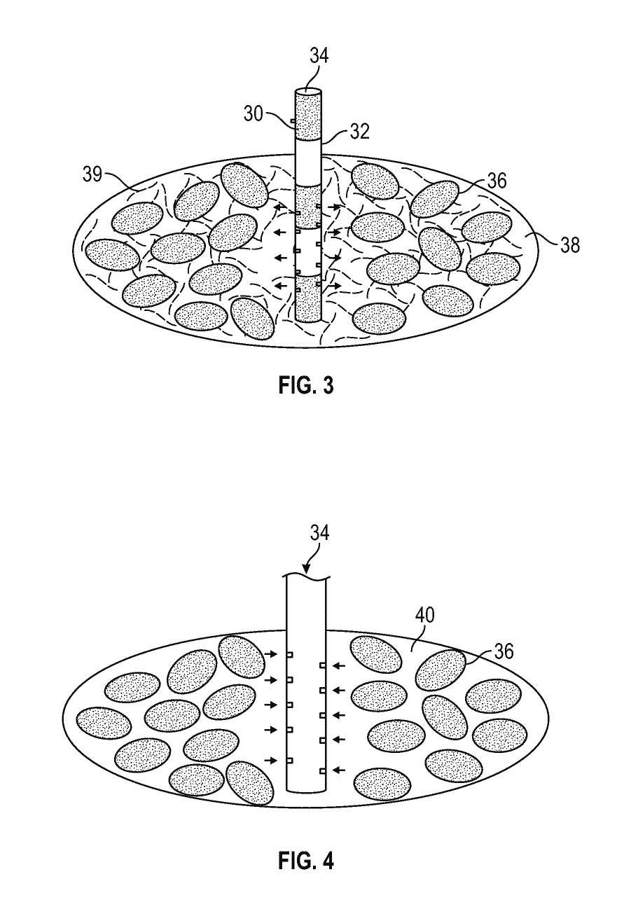

FIG. 3 shows a schematic of the above described pulsed stimulation treatment. Specifically, alternating slugs of non-degradable fibers and proppant, also referred to as a dirty slug 30, and slugs of degradable fibers without proppant, also referred to as a clean slug 32, are pumped down a wellbore 34 where they fracture and/or enter the formation. Proppant packs 36 are formed that contain the non-degradable fibers and the proppant, while the degradable fibers 39 or particulates from clean slug 32 reside in the spaces between the packs 38. FIG. 4 shows a schematic of FIG. 3 after sufficient time has passed for the degradable fibers or particulates to degrade and be removed from the spaces surrounding the proppant packs 36 opening channels 40 that allow fluid to flow freely around the proppant packs and be produced into the wellbore 34.

In one or more embodiments, a stimulation job may be performed by a pulsed application of fracturing fluids where a fracturing fluid containing degradable fibers or particulates and non-degradable fibers is continuously pumped downhole with the proppant being added at determined intervals to create an alternating series of clean and dirty slugs. The application of alternating pulses of fracturing fluid including a “dirty” slug (i.e., including proppant) and a “clean” slug (i.e., not including proppant) may result in the heterogeneous placement of proppant within a fracture. In these embodiments, the proppant pillars or packs that form within the fracture will include an intimate mixture of each of the components indicated above. Thus, the proppant packs may resemble those shown in FIGS. 1 and 2, which are described above. In short, upon the degradable components removal from the proppant packs, the proppant packs may have micro-channels formed therein that could increase the conductivity of produced fluids as they flow from within the fracture and out to the wellbore during production. Further, as a result of the heterogenous proppant placement achieved by alternately pulsing clean and dirty slugs during the stimulation treatment, well defined proppant packs are formed that are surrounded by channels that do not include proppant but do include degradable and non-degradable fibers. Fluid conductivity is increased in these channels surrounding the proppant packs as the degradable components of the emplaced fracturing fluids are removed. Therefore, in the embodiments where the proppant is added at determined intervals to a continuously pumped fluid that contains both degradable fibers or particulates and non-degradable fibers, the fluid conductivity both through the channels around the proppant pillars and through the microchannels within the proppant pillars themselves may be increased once the degradable components are removed.

Without being bound by theory, it is believed that by coupling degradable and non-degradable fibers a synergy may be created that builds on the strengths of each type of fibers while reducing or eliminating the drawbacks to using each type of fiber alone. For example, when following one or more of the embodiments described above a higher fluid conductivity within the fracture may be achieved when compared to the use of non-degradable fibers alone, while the stability and integrity of the proppant packs may not be diminished when compared to the use of degradable fibers or particulates alone.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method of treating a formation, comprising:
pumping a fracturing fluid comprising proppant, non-degradable fibers, and a degradable component into fractures in the formation.

2. The method of claim 1, wherein the degradable component comprises at least one material selected from the group consisting of substituted and unsubstituted lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, polyesters, and mixtures thereof.

3. The method of claim 1, wherein the non-degradable fibers are at least one of cellulosic fibers comprising cellulose acetate, nanocellulose, or pulp; synthetic fibers comprising polyolefin-based fibers, polyamide fibers, or acrylic fibers; or a mixture of cellulosic fibers and synthetic fibers.

4. The method of claim 1, wherein the pumping of the fracturing fluid is continuous.

5. The method of claim 1, further comprising pumping a pad fluid at a pressure sufficient to initiate the fractures in the formation.

6. The method of claim 1, further comprising allowing the degradable component to degrade and be removed.

7. The method of claim 6, wherein micro-channels are formed within a proppant pack formed from the pumping after the degradable component degrades and is removed.

8. The method of claim 1, wherein the non-degradable fibers have a length of about 250 microns to 10 millimeters.

9. The method of claim 1, wherein the degradable fibers have a length of about 1 mm to 30 mm.

10. The method of claim 1, wherein the non-degradable fibers have a width of about 500 nanometers to 500 microns.

11. The method of claim 1, wherein the total amount of non-degradable fibers and degradable component, within the fracturing fluid is from about 0.01% to 2% by weight of the fracturing fluid.

12. The method of claim 1, wherein the weight percent of non-degradable fibers to the total amount of degradable component is between about 5% to 95%.

13. A fracturing fluid, comprising:
an aqueous base fluid;
a proppant material;
non-degradable fibers; and
a degradable component.

14. A method of treating a formation, comprising:
alternately pumping a first fracturing fluid comprising proppant into a wellbore penetrating the formation and pumping a second fracturing fluid that is substantially proppant-free into the wellbore penetrating the formation, wherein at least one of the first fracturing fluid and the second fracturing fluid comprise a non-degradable fiber.

15. The method of claim 14, wherein both the first and second fracturing fluids contain the non-degradable fiber.

16. The method of claim 14, wherein at least one of the first and second fracturing fluids contain a degradable component.

17. The method of claim 14, wherein only the second fracturing fluid contains the degradable component.

18. The method of claim 14, wherein both the first and second fracturing fluids contain the degradable component.

19. The method of claim 16, further comprising allowing the degradable component to degrade and be removed.

20. The method of claim 19, wherein channels are formed around proppant packs formed from the pumping after the degradable component degrades and is removed.
